(19) United States
(12) Patent Application Publication
(10) Pub. No.: US 2005/0114466 A1
(43) Pub. Date: May 26, 2005

(54) Data transfer device and system

(76) Inventor: Samuel Doyle, Ottawa (CA)

Correspondence Address: Ian Fincham;McFadden, Fincham, Suite 606, 225 Metcalfe Street, Ottawa, ON, K2P 1P9, CA

(21) Appl. No.: 10/738,140

(22) Filed: Dec. 18, 2003

(30) Foreign Application Priority Data
Nov. 25, 2003 (CA) 2,450,520

(51) Int. Cl. G06F 15/16

(52) U.S. Cl. 709/217

(57) ABSTRACT

In the present invention there is provided a device for direct data transfer of stored data from a host data storage device to a target data storage device, comprising: a housing; data transfer means within the housing; first connection means associated with the housing, the first connection means being compatible with a connection means on the host device; and second connection means associated with the housing, the second connection means being compatible with a connection means on the target device. The first connection means includes a plurality of connection ports, second connection means includes a plurality of connection ports, the plurality of connection ports include serial, infrared, USB and bluetooth interfaces, the device further includes data storage means, the host device is a handset or PDA, and the target device is a handset or PDA.

### BACKGROUND OF THE INVENTION

1. Field of the Invention

The present invention is concerned with the transfer of data from one electronic device to another. More specifically, the present invention is concerned with a device and a system for the transfer of data between electronic devices having different data transfer protocols.

2. Prior Art

The computer industry has been working towards standardizing the transfer of data from one electronic device to another. However, the industry has been slow to accommodate the user being able to transfer regularly used data, e.g. telephone book lists, email addresses, calender information, etc., between devices having different data transfer protocols.

It should be understood by “data transfer protocol” that reference is being made to the formal specifications, e.g. hardware and software, of methods, whereby data communication over a data link are performed in terms of the particular transmission mode, control procedures and recovery procedures.

Typically, when purchasing a new or upgraded handset or PDA, the consumer will have the time consuming task of reprogramming the new handset with the information previously stored in the old handset or PDA. An individual will simply manually reenter the required information in the new handset or PDA. Depending on the amount of information stored, this can be a very time consuming task.

There are currently commercially available software products which permit cross transfer of data betw en handsets and/or PDAs. However, these products are usually specific to a certain make or model of a single manufacturer and are not universally adaptable to several makes and models.

Further, the currently available software which functions to transfer data must be typically installed on a third “mediating” computer. The handset or PDA from which the information is to be extracted would then be connected to the computer, following which the software executes to retrieve and store the data from the handset or PDA to the computer. This involves storing the data from the first device onto the third computer in order for the software to reconfigure the data for compatibility with the application format of the second device. The user must then disconnect the handset from which the information has been extracted and connect the target handset to the third computer for the data to be transferred. The software will then transmit the reconfigured data from the computer to the desired target handset or PDA. This process can be fairly time consuming.

The process can be further exhausted if the connection ports for any or all of the devices are not compatible. This involves the user having to install corresponding connection ports for each of the host and target devices to the third computer for communication between the devices to occur.

Various data retrieval/transfer and storage systems are known in which devices are capable of retrieving data from a digital appliance and storing the retrieved data. Typical of such a data retrieval and storage system is that shown in Canadian Published Patent Application 2,324,006. This publication teaches a data storage device connectable to a digital appliance to provide a direct communication path for digital data transferred between the digital appliance and the data storage device.

Canadian Published Patent Application 2,309,833 also discloses a portable data storage device for connecting to digital appliances and which automatically downloads digital data from the digital appliance and stores the retriev d data in a data storage device.

As set out abov, the pr sent art do s not consider the dir ct transfer of one or more data sets from an electronic device to another electronic device with each having different data transfer protocols.

Thus, there is a need for a device and a system in which a user can simply and efficiently transfer one or more data sets of information between the host and target device without the inconvenience of having to first store the data set on a third device. There is a further need for a system which includes several connection ports to avoid the need to install a different connection port in the event a target device is upgraded.

### SUMMARY OF THE INVENTION

According to one embodiment of the present invention, there is provided a device for constant data transfer of stored data from a host data storage device to a target data storage device, comprising a housing, data transfer means within said housing; first connection means associated with said housing, said first connection means being compatible with a connection means on said host device; and second connection means associated with said housing, said second connection means being compatible with a connection means on said target device.

In the apparatus of the present invention, desirably the first connection means includes a plurality of connection ports. Still further, a preferred embodiment is where the device includes a plurality of connection ports, such as ports which ar adapted to provide serial, infrared, USB and bluetooth interfaces.

Still further, another preferred embodiment of the present invention is where the device includes data storage means. Another embodiment is where the first and second connection means are at opposed ends of said housing.

The apparatus of the present invention is preferably used with a host device such as a handset or PDA.

In another embodiment of the present invention, ther is provided a system for the transfer of data from a first data storage device to a s cond data storage device, said system comprising:
a first data storage device having at least one data set;
a second data storage device;
a data transfer device adapted to be connected to the first data storage device and the second data storage device, the data transfer device having a processing means for transferring the data set from the first data storage device directly to the second data storage device without transferring the data set into the data transfer device.

Preferably, the data transfer device further includes memory means operatively associated with the processing means, the memory means having algorithm instances for communication between a first device and a second device, the processing means further includes authentication means, interface means and transfer means.

It is desirable the first device and the second device further include identification coding generic to each of the first data storage device and the second data storage device, the authentication means confirms connection of the first data storage device and the second data storage device to the data transfer device, authenticates the identification coding and outputs a signal to the interface means.

Further, it is desirable the interface means generates a suitable algorithm instance from the memory means to transfer the data set from the first data storage device to the second data storage device and outputs a signal to the transfer means to initiate data transfer.

It is further desirable the transfer means retrieves the data set from the first data storage device and transfers the data set dir ctly to the second data storage device.

Pr ferably, th syst m further includes a display monitor for a user to monitor the transfer of the data set, the processing means further includes network communication means for transferring data from remotely connected first and second data storage devices, the data set comprises contact data, calender data, photos, music files, ring tones, or text messaging data, and a plurality of data sets are transferred simultaneously.

In another embodiment of the present invention, there is provided a system for the transfer of data from a first device to a second device, the system comprising:
a first device having a first connection means, a first storage means, at least one data set stored in the storage means and a first data application means operatively associated with the at least one data set and the storage means;
a second device having a second connection means, a second storage means different from the first data application means and being for storing at least one data set and a second data application means and being operatively associated with the second storage means and to be operatively associated with the at least one data set;
a data transfer device including a processing means, a memory means and at least two connection means for connecting to the first connection means
and to the second connection means, the processing means having authentication means, interface means, transfer means and being operatively associated with the memory means;
the authentication means for identifying the first and the second data application means when the first device and the second device ar connected to the data transfer device and outputting a signal to the interface means,
the interface means for generating a suitable interface to transfer the at l ast one data set from the first d vice to th s cond d vice wh rein the at least one data set is operatively associated with the second data application means and the second storage means and outputting a signal to the data transf r means,
the data transfer means transferring the at least one data set from the first device directly to the second device.

It is desirable the system further includes a display for a user to monitor the transfer of the data set, the processing means further includes network communication means for transferring data from remotely connected first and second devices.

The device of the present invention provides several advantages over conventional technology including providing a simple device which enables fast transfer of data from one data storage unit to a second unit such as a PDA or other handset. The device of the present invention is economical to manufacture and use and can be adapted to a very wide range of known handsets or PDA's in order to provide th same data to a new PDA or handset. Moreover, a device of the present invention is simple to operate and does not require a high degree of skill to connect to known devices.

Suitable power supply means can be provided to power the unit of the present invention, either using standard household current or a battery system. Alternatively, depending on the type of handset or PDA, power may be derived from either a host unit or a new handset or PDA as required.

In use, an existing PDA, or other electronic device, will be connected through the appropriate port(s) to the unit of the present invention and upon actuation of the device of this invention, data can be readily transferred through the outlet port(s) to a new PDA or other electronic device.

### BRIEF DESCRIPTION OF THE DRAWINGS

Having thus generally described the invention, ref rence will be made to the following drawings, describing preferred embodiments. In the drawings:

FIG. 1 of the drawings illustrat s the desk top device of the pr sent invention;

FIG. 2 is a schematic illustration illustrating the desk top device of the present invention together with the host device and the target device; and,

FIG. 3 is a diagrammatic flow-chart illustrating the the present invention in use.

### DETAILED DESCRIPTION OF THE PREFERRED EMBODIMENTS

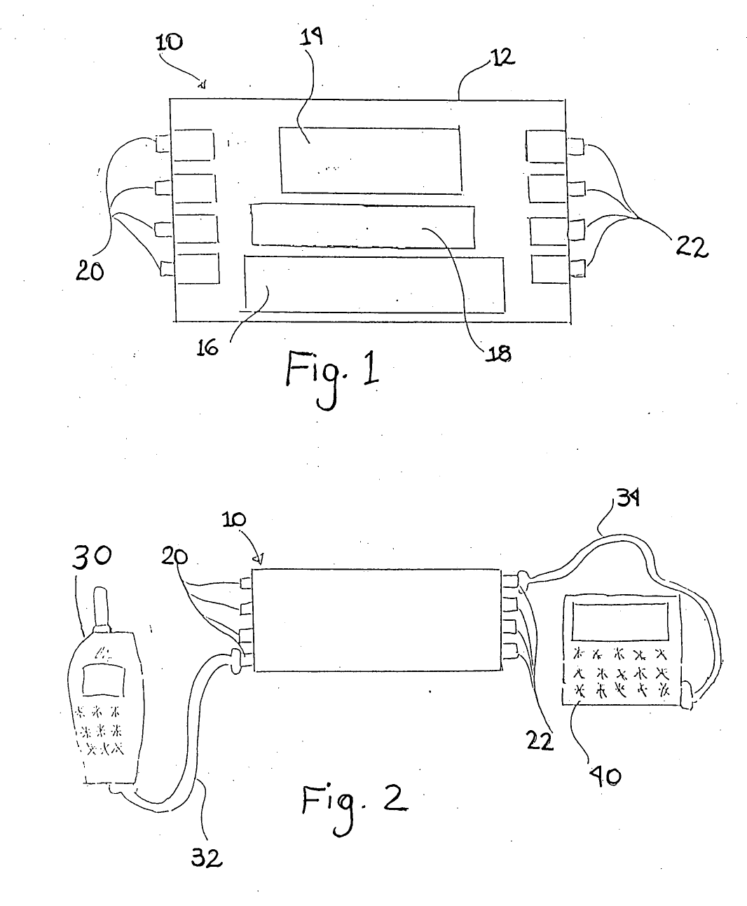

Reference will initially be made to FIG. 1 of the drawings which illustrates the device of the present invention, generally designated with reference numeral 10.

The device 10 includes a housing 12 which has an internal storage component or memory means 14 and a processing means 16. The processing means 16 is operative with the memory means 14 and permits the simultaneous retrieval of data from a host communication device and the transfer of the data to a second target communication device. More specifically the processing means 16 and memory means 14 are typically found in a central processing unit (CPU). The processing means 16 includes software to effect authentication, interfacing and the transfer of data from the host device to the target device.

The device 10 can be adapted to output details of the progress of the data transfer to the user. This may be accomplished by any conventional means such as a display monitor, LCD or the like. The housing 12 has a plurality of host connection means or ports 20 for the connection of a host device thereto. The housing 12 is also provided with a plurality of target connection means or ports 22 for th connection of a target device thereto. The host and target connection means or ports 20, 22 can be any known connection ports, such as USB, serial, infrared, Bluetooth™, etc. Preferably, th housing 12 has a plurality of differ nt types of connection ports.

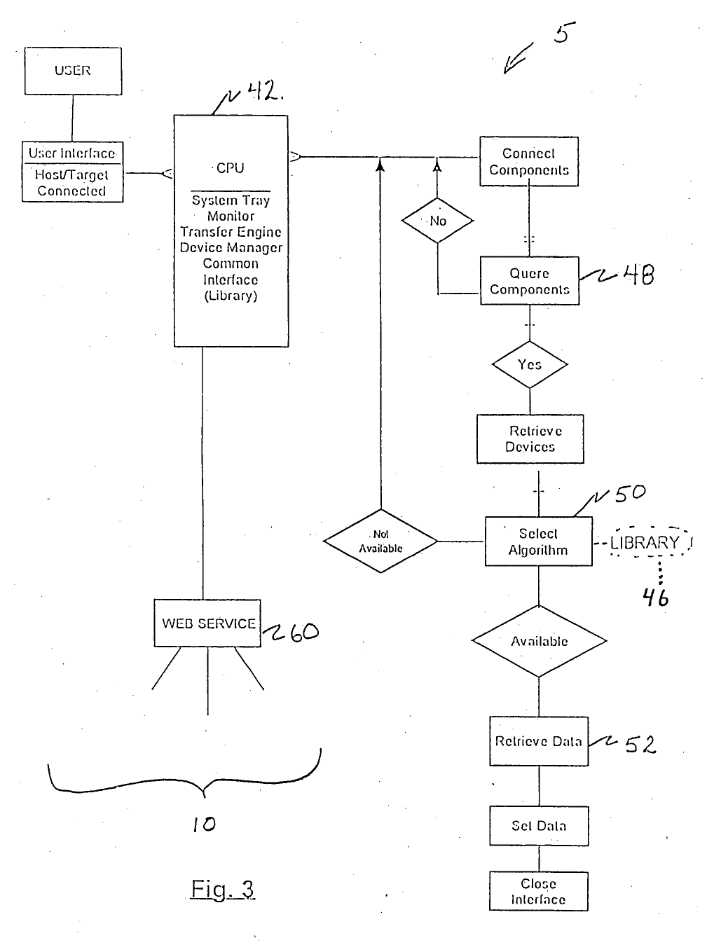

Referring now to FIG. 2, this figure shows the device 10 of the present invention to which is connected a host device 30 from which data is to b retri ved and a target device 40 to which the retrieved data is to be transferred. In FIG. 2, the host device 30, shown as a handset, is connected to a suitable host connection means 20 through the use of a cable 32. At the same time, the target device 40, shown as a PDA, is also connected to a suitable target connection means 22, through a further cable 34. As will be appreciated in some instances, such as infrared, a connection cable would not be required.

The device 10 enables the direct transfer of data stored within the host device 30 to the target device 40. Such data could include, but not be limited to, contact information, email, user preferences and any other information considered of value to the user.

The device 10 of the present invention could also be provided with a mechanism for future software upgrades to support new handsets or PDAs, as introduced by hardware vendors hence providing a long term flexible mechanism for providers to support new product lines.

The device 10 could also be provided with means for access to the internet or intranet to report alarms or be notified when software upgrades become available.

FIG. 3 diagrammatically illustrates the system 5 of the present invention, namely the host and target devices in operation with the data transfer device 10, wherein the user updates or adds data stored in the host device, e.g. handheld wireless cell phone, Nokia 5190 model (not shown), to the target device, e.g. Personal Digital Assistants (PDA not shown). The user connects both the host and target devices to the housing 12 by conventional means as discussed above.

The CPU 42 includ s both the processing m ans 44 and th m mory means 46. The processing means 44 further includes an authentication means 48, interface means 50 and transfer means 52. Optionally, a web service download/upload manager is included in th processing means 44 for n twork communications. The authentication means 48 is a device connectivity monitor singleton running synchronously with the interface means 50. The device connectivity monitor identifies the connection of the data transfer device of the present invention to the connection means or ports, e.g. USB, etc., for both the host and target devices. The connectivity monitor also authenticates the coding systems generic to a manufacturer's make and model which are embedded in the host and target devices. These coding systems are well known and are typically identifiable by available software development kits (SDK's).

The authentication means 48 preferably outputs the connection status of th component(s) to a system tray in the processing means 48 which in turn displays the system's connective status to the user as described herein above, i.e. connected, disconnected and reconnected to the host and target components. The authentication means 48, having identified and authenticated the host and target devices and their respective coding systems, outputs a signal to the interface means 50. The interface means 50 is a common interface having a device manager which scans for the SDK's of the host and target devices and retrieves complementary coding systems from the memory means 46 to generate a compatible algorithm instance which enables the host and target devices to communicate. Thus, the interface means 50 retrieves the data application means, or coding derived from the classes of component codes for each host and target device and the complementary coding systems for each device from the memory means 46 to generate the algorithm instance. In the event that a compatible algorithm instance is not detected the interface means 50, or the device manager, outputs a signal to the system tray notifying the user.

The interface means 50 signals the transfer means 52, which is a data transfer engine, to initiate transfer of the data from the first host device to the second target device. The interface means 50, or common interface operates with the device manager and the data transfer engine to synchronously and directly xecute the transf r of data between th host and target compon nts. The user is notified of the progression and statistics of the transfer by the common interface and the data transfer engine via the system tray.

The data transfer progression and specifications are preferably recorded in the memory means 46 of the system. Such specifications include, but are not limited to, the status of the connection, synchronization, downloading and/or uploading progression, and the mode of data transfer.

The user is notified once the transfer of data is complete that the system is ready for the transfer of further data. The devices can be disconnected from the housing or additional data can be selected for transfer.

It will be understood by those skilled in the art that appropriate algorithms can be formulated to create the necessary functions of the system of the present invention; such algorithms can be modified algorithms known to those skilled in the art or alternatively generated specifically for the system. It will also be understood by those skilled in the art that the memory means 46 is a library which can be updated to include the appropriate algorithms generated or modified therein.

The system can be configured to run as an individual application or as part of a plurality of programs on an operating system such as a standard Windows™ application. The system is also adapted for use with a conventional communications network 60. The Web Service Manager facilitates and supports data transfer between host and target components by way of web-based application when the user is unable to access a kiosk or a vendor-type system. As will be understood to those skilled in the art, a web-based application will further require dedicated hardware and software devices necessary for the transmission and receipt of signals in a network environment to transfer the host and targ t component data and also to manage the system as described herein above.

Optionally, th system can generat a work product output generating th recorded details of the data transfer.

It will be understood that various modifications can be made to the preferred embodiments of the present invention, without departing from the spirit and scope thereof.

1. A device for direct data transfer of stored data from a host data storage device to a target data storage device, comprising:
a housing
data transfer means within said housing;
first connection means associated with said housing, said first connection means being compatible with a connection means on said host device; and
second connection means associated with said housing, said second connection means being compatible with a connection means on said target device.

2. The device as claimed in claim 1, wherein said first connection means includes a plurality of connection ports.

3. The device as claimed in claim 1 or 2, wherein said second connection means includes a plurality of connection ports.

4. The device as claimed in claim 2 or 3 wherein said plurality of connection ports include serial, infrared, USB and bluetooth interfaces.

5. The device as claimed in any one of claims 1 to 4, wherein said device further includes data storage means.

6. The device as claimed in any one of claims 1 to 5, wherein said host device is a handset or PDA.

7. The device as claim d in any one of claims 1 to 6, wherein said target device is a handset or PDA.

8. A system for the transfer of data from a first data storage device to a second data storage device, said system comprising:
a first data storage device having at least one data set;
a second data storage device;
a data transfer device adapted to be connected to said first data storage device and said second data storage device, said data transfer device having a processing means for transferring said data set from said first data storage device directly to said second data storage device without transferring said data set into said data transfer device.

9. The system as claimed in claim 8, wherein said data transfer device further includes memory means operatively associated with said processing means, said memory means having algorithm instances for communication between a first device and a second device.

10. The system as claimed in claim 8 or claim 9, wherein said processing means further includes authentication means, interface means and transfer means.

11. The system as claimed in claim 10, wherein said first device and said second device further include identification coding generic to each of said first data storage device and said second data storage device, said authentication means confirms connection of said first data storage device and said second data storage device to said data transfer device, authenticat s said identification coding and outputs a signal to said interface means.

12. The system as claimed in claim 10 or claim 11, wher in said interface means g nerates a suitable algorithm instance from said memory means to transfer said data set from said first data storage device to said second data storage device and outputs a signal to said transfer means to initiate data transfer.

13. The system as claimed in claim 10, wherein said transfer means retrieves said data set from said first data storage device and transfers said data set directly to said second data storage device.

14. The system as claimed in any one of claims 8 to 13, wherein said system further includes a display monitor for a user to monitor the transfer of the data set.

15. The system as claimed in any one of claims 8 to 14, wherein said processing means further includes network communication means for transferring data from remotely connected first and second data storage devices.

16. The system as claimed in any one of claims 8 to 15, wherein said data set comprises contact data, calender data, photos, music files, ring tones, or text messaging data.

17. The system as claimed in any one of claims 8 to 16, wherein a plurality of data sets are transferred simultaneously.

18. A system for the transfer of data from a first device to a second device, said system comprising:
a first d vice having a first connection means, a first storag means, at least one data set stored in said storage means and a first data application m ans op rativ ly associat d with said at l ast one data s t and said storage means;
a second device having a second connection means, a second storage means different from said first data application means and being for storing at least one data set and a second data application means and being operatively associated with said second storage means and to be operatively associated with said at least one data set;
a data transfer device including a processing means, a memory means and at least two connection means for connecting to said first connection means and to said second connection means, said processing means having authentication means, interface means, transfer means and being operatively associated with said memory means;
said authentication means for identifying said first and said second data application means when said first device and said second device are connected to said data transfer device and outputting a signal to said interface means,
said interface means for generating a suitable interface to transfer said at least one data set from said first device to said second device wherein said at least one data set is operatively associated with said second data application means and said second storage means and outputting a signal to said data transfer means,
said data transfer means transferring said at least one data set from said first device directly to said second device.

19. The system as claimed in claim 18, wherein said system further includes a display for a user to monitor the transfer of the data set.

20. The system as claim d in claim 18 or claim 19, wher in said processing means further includ s network communication means for transf rring data from remotely connected first and second devices.
